(19) United States
(12) Patent Application Publication
(10) Pub. No.: US 2026/0246788 A1
(43) Pub. Date: Aug. 20, 2026

(54) ANTI-SPAM CONVERSATION LOGIC

(71) Applicant: T-MOBILE INNOVATIONS LLC, Overland Park, KS (US)

(72) Inventor: Chingming CHAO, Bellevue, WA (US)

(21) Appl. No.: 19/058,820

(22) Filed: Feb. 20, 2025

(51) Int. Cl. H04L 9/40

(52) U.S. Cl. CPC H04L 63/1416

(57) ABSTRACT

Methods, media, and systems are provided for managing communication in a wireless telecommunication network. At an anti-spam manager serving a network node of a wireless telecommunications network, call logic is employed to evaluate whether the block a communication, monitor a user for potential communication blocking, or allow a communication. The call logic can analyze various metrics include a volume of outgoing communications associated with a user, a social graph of a user, historical activity of a user, keywords within communications, as well as other factors. The call logic can also utilize machine learning techniques to determine a context of a communication to aid in identifying the meaning within the communication (e.g., a single communication or a conversation over time), which decreases the likelihood of blocking a legitimate, non-spam communication while still maintaining thresholds to increase the likelihood of blocking spam communication.

### SUMMARY

A high-level overview of various aspects of the invention is provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitating anti-spam protections enabled by call logic, substantially as shown in and/or described in connection with at least one of the figures, and as set forth more completely in the claims.

In aspects set forth herein, and at a high level, the technology described herein relates to facilitating efficient communication blocking to enhance anti-spam protections. In aspects, an anti-spam server utilizes various call logic metrics and a rating to determine whether to block a communication, monitor a user, or allow a communication.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for managing communication in a wireless telecommunication network, in accordance with aspects herein;

FIG. 2 illustrates an example social graph for managing communication in a wireless telecommunication network, in accordance with aspects herein;

FIG. 3 illustrates another example social graph for managing communication in a wireless telecommunication network, in accordance with aspects herein;

FIG. 4 illustrates an example flowchart for managing communication in a wireless telecommunication network, in accordance with aspects herein;

FIG. 5 illustrates another example flowchart for managing communication in a wireless telecommunication network, in accordance with aspects herein; and

FIG. 6 depicts an example computing environment suitable for use in implementation of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

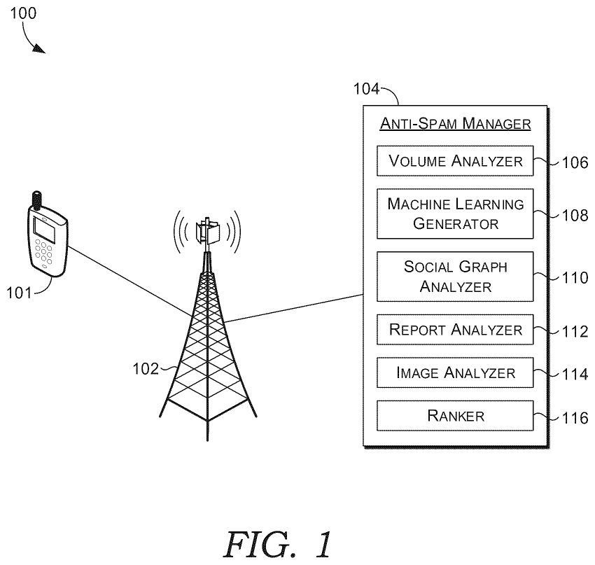

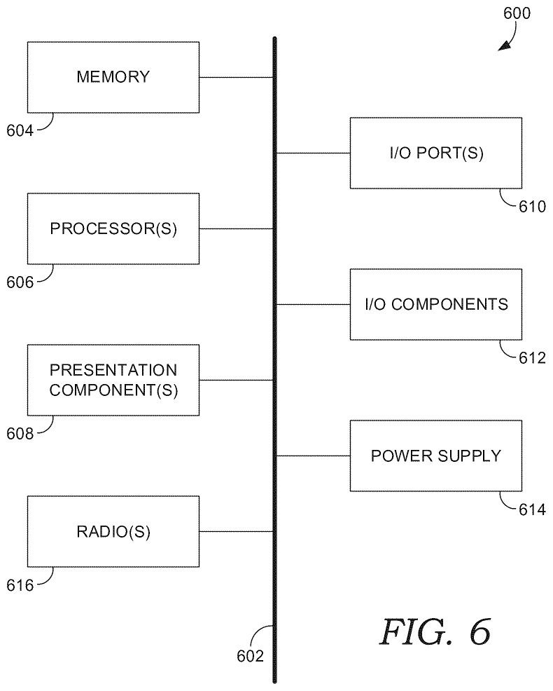

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 108, 110, or 112 described herein with respect to FIG. 1. A user device may also be, in another embodiment, similar to user device 600, described herein with respect to FIG. 6.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1xAdvanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1x circuit voice, a 3G network (e.g., CDMA, CDMA 2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, spam communications have been a nuisance for some time. In particular, spam text messages, are particularly problematic for both customers and mobile network operators (MNO). For customers, the spam text messages are highly annoying and distracting. They pose security risks to customer data and devices as spam text messages often contain phishing links or malware. This is a security risk to both the customer and the MNO as it may damage the MNO's reputation. Additionally, spam text messages are unnecessary, unwarranted, and unsolicited messages that are not desired on a network; hence, the unsolicited spam messages can clog up the network, leading to slower service and reduced network quality for legitimate uses. Globally, billions of malicious texts are sent each year.

In the past, MNOs have implemented various approaches to try and stop spam communications (i.e., spam text messages). For example, some techniques tried in the past include volume checks (i.e., sending too many messages in a short time period), evaluation of 7726 and 7727 reports (mechanism to report spam text messages to a MNO), and image analysis to detect a presence of Uniform Resource Locators (URLs) in a text message. These techniques have been individually applied in isolated environments and further fail to eliminate conversational spam. Conversational spam, as used herein, refers generally to a text message (or other communication) that is unsolicited by a receiving user and comprise a friendly greeting to start a conversation with the receiving user. This tactic is employed to gain the receiving user's trust and potentially manipulate them into sharing information or money. Due to the harmless nature of the initial message, this type of spam often goes undetected. Aspects herein seek to eliminate conversational spam and block initial spam message attempts.

In a first aspect, method is provided for managing text communications. The method comprises identifying a volume of communications originated for an identifier; establishing a number of connections for the identifier; determining a rating for the identifier, wherein the rating is based on historical activity for the identifier, the volume of communications exceeding a predetermined volume threshold, and the number of connections for the identifier exceeding a predetermined connection threshold; and based on the rating for the identifier, blocking a first communication from the identifier to a user equipment (UE).

In a second aspect, a system is provided for managing text communications. The system comprises a node having one or more antennas, the node being associated with a wireless telecommunication network; one or more processors communicatively coupled with the node; and computer memory storing computer-usable instructions that, when executed by the one or more processors, perform operations comprising: identifying a volume of communications originated for an identifier; establishing a number of connections for the identifier; determining a rating for the identifier, wherein the rating is based on historical activity for the identifier, the volume of communications exceeding a predetermined volume threshold, and the number of connections for the identifier exceeding a predetermined connection threshold; and based on the rating for the identifier, blocking a first communication from the identifier to a user equipment (UE).

In a third aspect, one or more non-transitory computer storage media having computer-executable instructions embodied thereon is provided, that when executed by at least one processor, cause the at least one processor to perform a method. The method includes, identifying a volume of communications originated for an identifier; executing conversational analytics on the communications to identify a context of the communications; establishing a number of connections for the identifier; determining a rating for the identifier, wherein the rating is based on historical activity for the identifier, the volume of communications exceeding a predetermined volume threshold, and the number of connections for the identifier exceeding a predetermined connection threshold; and based on the rating for the identifier, blocking a first communication from the identifier to a user equipment (UE).

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for managing communications within a wireless telecommunications network. Aspects are targeted herein to text communications but may be applicable to any communication in a wireless telecommunications network. The system includes components and interactions between the anti-spam manager (e.g., an anti-spam server) device and a network node to determine call logic metrics and rating scores, and communicate this information to optimize communication. Network environment 100 includes node 102 (e.g., base station), an anti-spam manager 104, and user device 101.

As mentioned, network environment 100 includes user device 101. In network environment 100, user device 101 may take on multiple forms, such as a mobile device (e.g., phone, smart phone), tablets, cameras, microphones, sensors, goggles, and glasses, to name a few, or any other device (such as the computing device 600) that communicates via wireless communications with the anti-spam manager 104.

In some aspects, the user device 101 may correspond to computing device 600 in FIG. 6. Thus, user device can include, for example, a display(s), a power source(s) (e.g., a battery), a data store(s), a speaker(s), memory, a buffer(s), a radio(s) and the like. In some implementations, for example, user device 101 comprises a wireless or mobile device with which a wireless telecommunication network(s) can be utilized for communication (e.g., voice and/or data communication). In this regard, the user device 101 can be any mobile computing device that communicates by way of a wireless network, for example, a 3G, 4G, 5G, 6G, LTE, CDMA, or any other type of network. In some cases, user device 101 in network environment 100 can optionally utilize one or more communication channels (not shown) to communicate with other computing devices (e.g., a mobile device(s), a server(s), a personal computer(s), etc.) through the anti-spam manager 104 and node 102. Node 102 may be a gNodeB, eNodeB, or the like.

The network environment 100 may be comprised of a telecommunications network(s) (not shown), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

In some implementations, node 102 is configured to communicate with user device 101 and anti-spam manager 104. As such, radio antennas of node 102 may send and receive communications to and from the anti-spam manager 104. Node 102 may include one or more base stations, base transmitter stations, radios, antennas, antenna arrays, power amplifiers, transmitters/receivers, digital signal processors, control electronics, GPS equipment, and the like.

The anti-spam manager 104 employs call logic to determine when to block a communication, monitor a user, or allow a communication. In aspects herein, text communications are described but the anti-spam manager 104 can apply the call logic to a variety of communications and is not limited solely to text (SMS) messaging. Integrated within the anti-spam manager 105 or separate from the anti-spam manager 105 is a volume analyzer 106, a machine learning generator 108, a social graph analyzer 110, a report analyzer 112, an image analyzer 114, and a ranker 116.

The volume analyzer 106 can identify a volume of communications originating from a source. The source can be a mobile device identifier such as an international mobile equipment identity (IMEI), a mobile station international subscriber directory number (MSISDN; phone number assigned to the mobile device), an international mobile subscriber identity (IMSI), a serial number of a mobile device, and the like. MNOs often have threshold limits associated with communication volume such that a number of outgoing communications (e.g., text messages) in a predetermined time period that exceeds a predetermined volume threshold is identified as originating from a potential bad actor (e.g., spammer). Exemplary limits can be 500 text messages in a 24 hour period, 200 text messages in a 24 hour period, and the like. The predetermined volume threshold is a configurable threshold and can be adjusted by a MNO. In aspects, a high volume of communications (i.e., a volume that exceeds the predetermined volume threshold) is indicative of a spammer ranking while a low volume of communications that does not exceed the predetermined volume threshold is indicative of a non-spammer ranking.

The machine learning generator 108 can utilize machine learning techniques to analyze conversational spam. The machine learning generator 108 can monitor conversational communications in a gradual manner such that each time a new message is received from a sender (i.e., user originating the communication) the machine learning generator 108 updates a context. A context, as used herein, relies on a conversation in its entirety and refers generally to a meaning of a communication. When establishing context, the machine learning generator 108 reviews text communications that precede and/or follow a target text in order to understand the meaning of the target text. For instance, if a message reads “will you go?” and the previous message reads “the dance is at 7 pm on Friday,” then the context provided by the previous message (information regarding an event) allows the machine learning generator 108 to ascertain the meaning as an invitation to a dance at 7 pm on Friday. Some text messages alone may appear harmless but, when studied in their context (e.g., messages that precede and/or follow the text), are actually indicative of conversational spam.

The machine learning generator 108 also includes a keyword component that identifies predetermined keywords associated with spam communication. Exemplary keywords that may indicate spam communication are promotional keywords/content, references to money/investments/opportunities, solicitation attempts, and the like. Additional keywords/phrases that may indicate a spam communication include requests for user personal information, repeated requests to do the same task (e.g., click the link, let me tell you about my company, etc.), and the like.

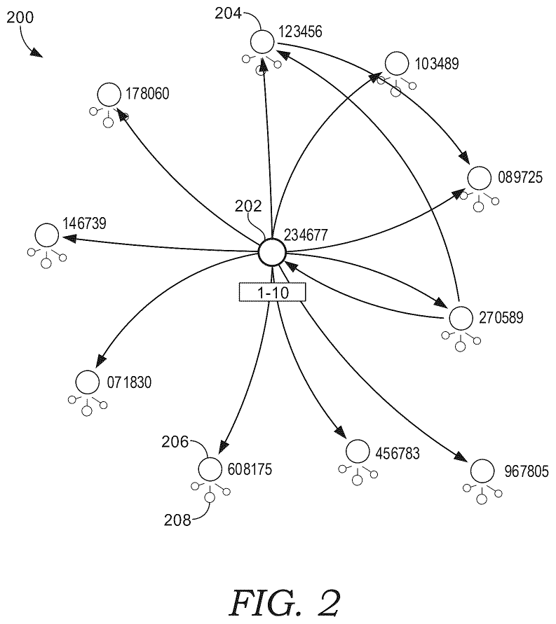

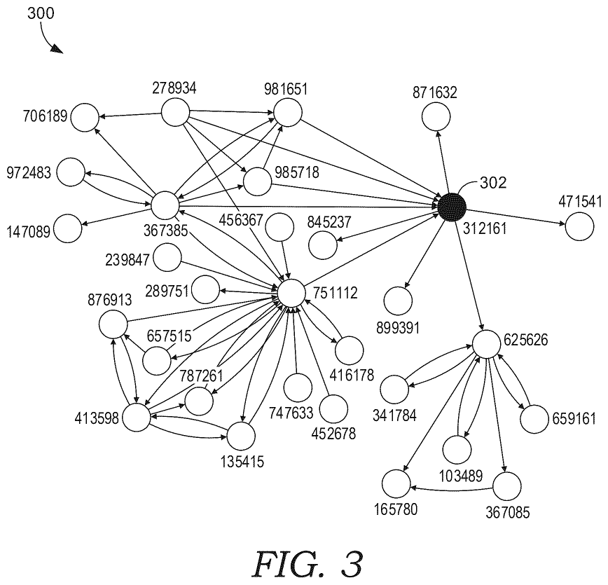

The social graph analyzer 110 can evaluate social connections of a user. In this case, the originating user (i.e., person sending the message) is analyzed to determine their social connections. An exemplary social graph 200 of a typical user 202 is illustrated in FIG. 2. As shown, user 202 has many 1:1 connections with other users such as user 204 and 206. Those users go on to have their own 1:1 connections with users, such as user 208. This is a typical social graph a MNO expects to see for legitimate users and actions on the network. In contrast, FIG. 3 illustrates a social graph 300 of a suspected bad actor. As is shown, user 302 has numerous 1:many connections instead of 1:1. User 302 connects with user 304. In aspects, 1:1 relationships on a social graph indicate a non-spammer ranking, while 1:many relationships indicate a spammer ranking. A user that has a number of connections exceeding a predetermined connection threshold may be associated with a spammer ranking.

The report analyzer 112 can evaluate 7726 and/or 7727 reports. 7726 and 7727 reports are reports that are generated based on user feedback of potential spam communications. 7726 and 7727 are mechanisms that are in place for a subscriber to report malicious or spam activity to a MNO and a 7726/7727 report is generated therefrom, such that the MNO can easily identify users/devices that have been reported for spam activity.

The image analyzer 114 can include an optical character recognition (OCR) functionality such that text messages (or other communications) can be parsed to identify the presence of a uniform resource location (URL) within the communication. URLs are often present in text communications as a means to get a user to click a malicious link such that the bad actor can gain access to the user's device or information.

The ranker 116 utilizes historical user information along with the call logic data described above to compile a ranking of a user. The ranking of a user indicates the likelihood of the user being a scammer/bad actor. The historical user information comprises historical actions associated with the MSISDN. For instance, the MSISDN may have been previously suspended for scam activity or associated with scam activity in a 7726/7727 report. Additionally the MSISDN is associated with an age. MSISDNs that are associated with an age over a predetermined age threshold generally indicate that the MSISDN is not a scammer but, rather, an established subscriber. Bad actors generally move around and obtain new numbers frequently. Thus, a MSISDN that is relatively new (e.g., an age under a predetermined age threshold) may indicate the likelihood of a bad actor is higher.

The anti-spam manager 104 utilizes all of the call logic data described above to determine when to block a communication, allow a communication, or monitor a communication/user based on a ranking score. The ranking score, as described above with respect to the ranker 116, can be adjusted based on the call metrics discussed herein. For instance, a new number in itself may not warrant classifying the user as a bad actor, but a new number in combination with a high volume of communications, a social graph of 1: many, or machine learned context indicative of spam, may result in the ranking score being adjusted to indicate a spammer.

When the ranking score is below a predetermined threshold, the anti-spam manager 104 can associate the user with a bad actor ranking and block the bad actor from the network for a predetermined time period (e.g., 24 hours). Thus, any communications attempted by the bad actor within the time period will be blocked. The anti-spam manager 104 can also permanently block the bad actor from the network after a predetermined number of bad actor associations and previous temporary blocks from the network. Put simply, if a bad actor is blocked from a network a predetermined number of times within a set time period, the bad actor may be permanently blocked.

When the ranking score is above a predetermined threshold, the anti-spam manager 104 can associate the user with a non-spammer ranking and allow communications to continue as usual. However, a ranking score above a predetermined threshold but below a certain threshold may indicate that the anti-spam manager 104 should further monitor the user. Additional monitoring may comprise evaluating historical user information further back that originally evaluated (e.g., review the last 5 years of activity vs 1 year of activity) or applying additional call logic metrics to the ranking. The ranking score may be originated using any one of the call logic metrics discussed herein or a combination thereof. If a ranking score has not utilized all of the metrics and the ranking score falls within a monitoring range, the anti-spam manager 104 can incorporate additional call logic metrics to further optimize the ranking score and obtain more accurate results. By way of example only, an original ranking score may only incorporate user history and volume and result in a monitoring range. In that instance, the anti-spam manager 104 can incorporate the social graph data, machine learning data, and the like into the ranking score to further optimize the accuracy of the score.

The ranking score can be stored at the network such that future communications from the user are automatically associated with the ranking score. The ranking score can be modified for a user at predetermined time intervals such that new data (like machine learning data) is obtained and the ranking score remains accurate. The ranking score can also be updated in real-time with every communication.

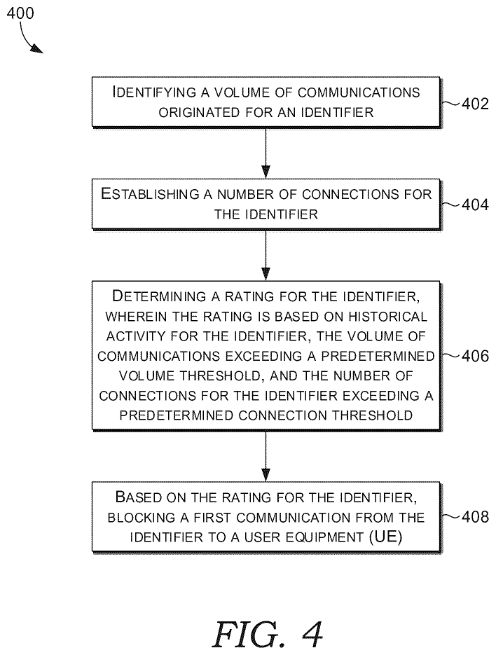

FIG. 4 illustrates an example flowchart of a method 400 for managing communications, in accordance with aspects herein. At block 402, a volume of communications originated for an identifier is identified or determined. The identifier can be a mobile phone number for a device. At block 404, a number of connections is established for the identifier. At block 406, a rating is determined for the identifier. The rating can be based on historical activity for the identifier, the volume of communications exceeding a predetermined volume threshold, and the number of connections for the identifier exceeding a predetermined connection threshold. At block 408, based on the rating for the identifier, a first communication from the identifier to a user equipment (UE) is blocked.

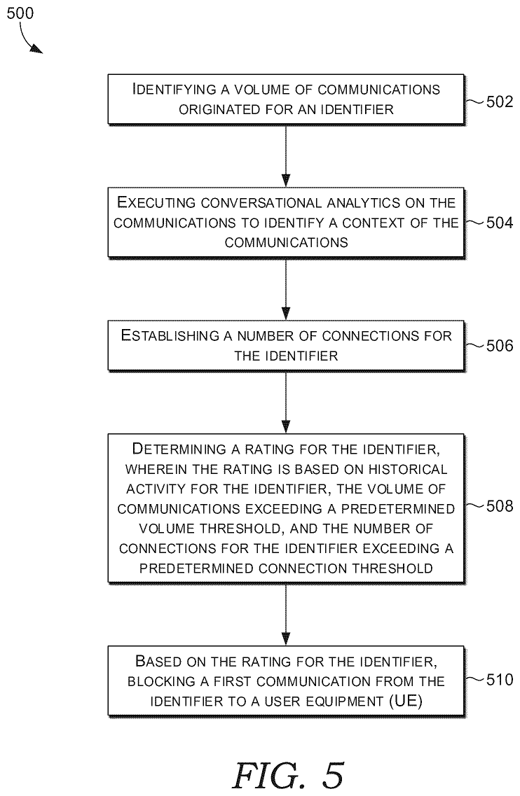

Turning now to FIG. 5, FIG. 5 illustrates another example flowchart of a method 500 for managing communications, in accordance with aspects herein. At block 502, a volume of communications originated for an identifier (e.g., mobile phone number) is identified. At block 504, conversational analytics is executed on the communication to identify a context of the communications. Conversational analytics can refer to machine learning techniques to ascertain a meaning or intent of a communication. At block 506, a number of connections is established or identified for the identifier. The number of connections may be identified using a social graph. At block 508, a rating is determined for the identifier. The rating can be based on historical activity for the identifier, the volume of communications exceeding a predetermined volume threshold, and the number of connections for the identifier exceeding a predetermined connection threshold. At block 510, based on the rating for the identifier, a first communication from the identifier to a user equipment (UE) is blocked.

Having described the example embodiments discussed above of the presently disclosed technology, an example operating environment of an example user device (e.g., user device 102A of FIG. 1) is described below with respect to FIG. 6. User device 600 is but one example of a suitable computing environment, and is not intended to suggest any particular limitation as to the scope of use or functionality of the technology disclosed. Neither should user device 600 be interpreted as having any dependency or requirement relating to any particular component illustrated, or a particular combination of the components illustrated in FIG. 6.

As illustrated in FIG. 6, example user device 600 includes a bus 602 that directly or indirectly couples the following devices: memory 604, one or more processors 606, one or more presentation components 608, one or more input/output (I/O) ports 610, one or more I/O components 612, a power supply 614, and one or more radios 616.

Bus 602 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component, such as a display device, to be an I/O component. Also, processors have memory. Accordingly, FIG. 6 is merely illustrative of an exemplary user device that can be used in connection with one or more embodiments of the technology disclosed herein.

User device 600 can include a variety of computer-readable media. Computer-readable media can be any available media that can be accessed by user device 600 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 604 includes computer storage media in the form of volatile and/or nonvolatile memory. The memory 604 may be removable, non-removable, or a combination thereof. Example hardware devices of memory 604 may include solid-state memory, hard drives, optical-disc drives, other hardware, or one or more combinations thereof. As indicated above, the computer storage media of the memory 604 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 600, or one or more combinations thereof.

The one or more processors 606 of user device 600 can read data from various entities, such as the memory 604 or the I/O component(s) 612. The one or more processors 606 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 606 can execute instructions, for example, of an operating system of the user device 600 or of one or more suitable applications.

The one or more presentation components 608 can present data indications via user device 600, another user device, or a combination thereof. Example presentation components 608 may include a display device, speaker, printing component, vibrating component, another type of presentation component, or one or more combinations thereof. In some embodiments, the one or more presentation components 608 may comprise one or more applications or services on a user device, across a plurality of user devices, or in the cloud. The one or more presentation components 608 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 608 can present a visualization that compares a plurality of inspections of one or more cores of a central processing unit and a visualization of each task of each of the plurality of inspections.

The one or more I/O ports 610 allow user device 600 to be logically coupled to other devices, including the one or more I/O components 612, some of which may be built in. Example I/O components 612 can include a microphone, joystick, game pad, satellite dish, scanner, printer, wireless device, and the like. The one or more I/O components 612 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 608 on the user device 600. In some embodiments, the user device 600 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 600 may, additionally or alternatively, be equipped with accelerometers or gyroscopes that enable detection of motion. In some embodiments, the output of the accelerometers or gyroscopes may be provided to the one or more presentation components 608 of the user device 600 to render immersive augmented reality or virtual reality.

The power supply 614 of user device 600 may be implemented as one or more batteries or another power source for providing power to components of the user device 600. In embodiments, the power supply 614 can include an external power supply, such as an AC adapter or a powered docking cradle that supplements or recharges the one or more batteries. In aspects, the external power supply can override one or more batteries or another type of power source located within the user device 600.

Some embodiments of user device 600 may include one or more radios 616 (or similar wireless communication components). The one or more radios 616 can transmit, receive, or both transmit and receive signals for wireless communications. In embodiments, the user device 600 may be a wireless terminal adapted to receive communications and media over various wireless networks. User device 600 may communicate using the one or more radios 616 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 616 may facilitate communication via radio frequency signals, frames, blocks, transmission streams, packets, messages, data items, data, another type of wireless communication, or one or more combinations thereof. The one or more radios 616 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for managing text communications, the method comprising:
identifying a volume of communications originated for an identifier;
establishing a number of connections for the identifier;
determining a rating for the identifier, wherein the rating is based on historical activity for the identifier, the volume of communications exceeding a predetermined volume threshold, and the number of connections for the identifier exceeding a predetermined connection threshold; and
based on the rating for the identifier, blocking a first communication from the identifier to a user equipment (UE).

2. The method according to claim 1, wherein the communications are text communications.

3. The method according to claim 1, wherein the communications are originated at a first node, wherein the first node is an eNodeB or a gNodeB.

4. The method according to claim 1, wherein the historical activity for the identifier comprises an indication of a previous account suspension.

5. The method according to claim 1, wherein the predetermined volume threshold is five hundred text communications in a predetermined time period.

6. The method according to claim 1, wherein the number of connections is a number of connections over a predetermined connection that that are identified as greater than a 1to 1 ratio.

7. The method according to claim 1, further comprising analyzing the communications for one or more keywords associated with spam communications, wherein the one or more keywords are associated with spam communications based on a training set of data for a machine learning algorithm.

8. The method according to claim 7, wherein spam communication is an unsolicited communication originating from an unknown user.

9. A system for facilitating managing text communications, the system comprising:
a node having one or more antennas, the node being associated with a wireless telecommunication network;
one or more processors communicatively coupled with the node; and
computer memory storing computer-usable instructions that, when executed by the one or more processors, perform operations comprising:
identifying a volume of communications originated for an identifier;
establishing a number of connections for the identifier;
determining a rating for the identifier, wherein the rating is based on historical activity for the identifier, the volume of communications exceeding a predetermined volume threshold, and the number of connections for the identifier exceeding a predetermined connection threshold; and
based on the rating for the identifier, blocking a first communication from the identifier to a user equipment (UE).

10. The system according to claim 9, wherein the communications are text communications.

11. The system according to claim 9, wherein the historical activity for the identifier comprises an indication of a previous account suspension.

12. The system according to claim 9, wherein the predetermined volume threshold is five hundred text communications in a predetermined time period.

13. The system according to claim 9, wherein the number of connections is a number of connections over a predetermined connection that that are identified as greater than a 1to 1 ratio.

14. The system according to claim 9, wherein the one or more processors are further configured to perform operations further comprising analyzing the communications for one or more keywords associated with spam communications.

15. One or more non-transitory computer storage media having computer-executable instructions embodied thereon, that when executed by at least one processor, cause the at least one processor to perform a method comprising:
identifying a volume of communications originated for an identifier;
executing conversational analytics on the communications to identify a context of the communications;
establishing a number of connections for the identifier;
determining a rating for the identifier, wherein the rating is based on historical activity for the identifier, the volume of communications exceeding a predetermined volume threshold, and the number of connections for the identifier exceeding a predetermined connection threshold; and
based on the rating for the identifier, blocking a first communication from the identifier to a user equipment (UE).

16. The one or more non-transitory computer storage media of claim 15, wherein the method further comprises identifying an age of the identifier, wherein an age less than a predetermined age threshold is associated with a spam identifier.

17. The one or more non-transitory computer storage media of claim 15, wherein the method further comprises performing an image analysis of the communications to identify a uniform resource locator (URL) in the communications, wherein the presence of the URL with a request to select the URL is associated with a spam identifier.

18. The one or more non-transitory computer storage media of claim 15, wherein the conversational analytics is a machine learning algorithm.

19. The one or more non-transitory computer storage media of claim 15, wherein the communication is automatically blocked without user input.

20. The one or more non-transitory computer storage media of claim 15, wherein the method further comprising associating the identifier with a spam identifier to block the identifier for a predetermined period of time and to identify in the historical activity at a subsequent time that the identifier was previously associated with a spam identifier.
